(19) United States
(12) Patent Application Publication
(10) Pub. No.: US 2002/0124643 A1
(43) Pub. Date: Sep. 12, 2002

(54) Flexible optical fiber remote level sensor

(76) Inventor: Bruce Robinson, Ft. Wayne, IN (US)

Correspondence Address: Kenneth F Cherry (agent), 1533 Eastgate, Toledo, OH, 43614, US

(21) Appl. No.: 09/802,014

(22) Filed: Mar. 9, 2001

(51) Int. Cl. G01F 23/00

(52) U.S. Cl. 73/290 R

(57) ABSTRACT

This invention uses the change visual appearance on one end of a transparent probe when the opposite end contacts the surface of the liquid to be measured. A flexible fiber optic device is used to allow remote viewing or sensing with electronic sensors. The device includes the use of multiple probe levels to allow indication of a range of liquid levels. Optional use of a light source in low light conditions is also provided.

### CROSS REFERENCE TO RELATED APPLICATIONS

none

### STATEMENT REGARDING FEDERALLY SPONSORED RESEARCH OR DEVELOPMENT

This invention was not made under any federally sponsored research or development programs.

### REFERENCE TO MICROFICHE APPENDIX

none

### BACKGROUND OF THE INVENTION

Measuring the level of a liquid using a translucent rod, rods, or structure utilizing the refractive index change when a liquid is in contact with one end of the pellucid material has been used when incorporated in a filling cap or similar device. In this use a liquid level is visually indicated when light entering the usually flat surface of the indicating device is reflected in a different manner from the wetted and the non-wetted opposite end of the device. These indicators have been used for fuel, battery acid level and other applications.

An improvement utilizing light transmitting fibers is the subject of this invention. The light transmitting fibers allow remote viewing of the liquid level. Previous adaptations of the use of pellucid, translucent or transparent optical level indicators have been limited in that viewing was necessary at the tank or container. This limitation prevented the use of this principal to allow viewing from the dashboard of an automobile, in the cockpit of an aircraft, or other remote location.

### BRIEF SUMMARY OF THE INVENTION

A combination of a fiber optic transmission cable connected to a liquid level optical sensor on one end and a viewing device on the other end, thus allowing remote indication of liquid level without electrical or moving mechanical components. It is an object of this invention to use this principle to allow remote viewing of the liquid level. This will provide an advantage over existing measuring devices in that no electrical energy is required in the vapor space above the liquid and the simple optical device has no moving parts or complex electrical components subject to failure. In addition the device is resistant to failure induced by electromagnetic radiation, vibration, and mechanical malfunctions. A plurality of optical fibers may be used to produce the equivalent of a continuous level monitoring device. An automatic warning system may also be incorporated utilizing light detecting electronic devices which may be incorporated in conventional alarm circuits as appropriate.

### BRIEF DESCRIPTION OF THE SEVERAL VIEWS OF THE DRAWING

FIG. 1 shows the invention having one level probe with four sensing levels shown as element 8. Element 1 is the liquid holding vessel or tank. Element 2 is the means of attachment. Element 3 is the optical cable shown as a single ribbon cable unit. Element 4 is the readout with level indicating markings.

FIG. 2 shows the invention with element 7 having three separate level probes. Element 1 is the liquid holding vessel or tank. Element 2 is the means of attachment. Element 5 is the optical cables shown as three separate cables. Element 6 is the readout with level indicating markings.

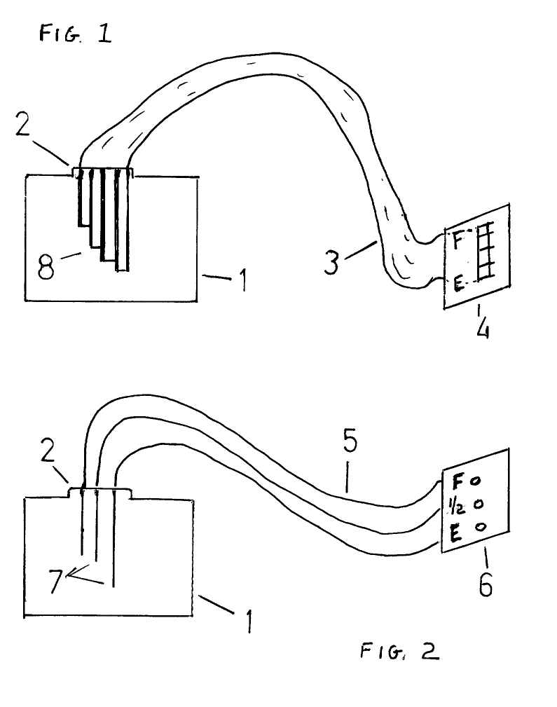

### DETAILED DESCRIPTION OF THE INVENTION

This invention is an improvement in the use of pellucid, transparent or translucent materials which can be configured to visibly indicate a liquid level when the liquid to be measured. The material of choice produces a visually discemable change in the appearance of the measuring element when liquid contacts the face this measuring element. For the purposes of this invention the term optically transparent includes any transparent, pellucid, or translucent material having the required properties. Various clear glass and plastic materials are suitable, depending on the refractive index of the liquid, the refractive index of the measuring element, color of the liquid and other liquid properties the various configurations of the liquid contacting surface are appropriate. For example flat shape, cone shape and prism shape interfaces have been used successfully. This invention improves the usefulness of prior devices by incorporating a fiber optic element allowing remote sensing of the liquid levels. The fiber optic element may be directly immersed in the liquid to be measured or placed in a position so that the visual changes in the measuring element are transmitted to a remote location allowing visual identification of the liquid level. The term fiber optic cable is intended to include any material including but not limited to glass and plastic light transmitting materials which function as described for this application.

A single liquid level-measuring device may be configured to have a single liquid level measurement location or a plurality of measuring levels. A plurality of measuring levels may include sufficient measurement levels to allow an approximation of continuous level monitoring. Using cut to length probe elements will virtually eliminate calibration concerns after initial verification of measurement accuracy.

A light source may be incorporated to facilitate identification of the liquid level in dim or dark circumstances. The light source may be added in the vessel containing the liquid, at the viewing end of the optical cable or in other locations as required.

The optical cable elements may be bonded to the measuring element to assure optimum alignment of the cable and concurrently prevent contaminants from interfering with the light transmission. An attachment means that preferably maintains optical cable alignment and reduces or eliminates introduction of contaminants into the viewing path is included as an element of this invention. This means of attachment may also incorporate the necessary elements to secure the device to the tank or vessel.

The inventor recognizes liquids that degrade the measuring element in such a way that the liquid interface is not detectable are not appropriate for use with this improvement.

The remote viewing location or readout preferably includes markings that allow the user to readily determine the liquid level. For example in English speaking applications the letter F can be used at one end of the remote read out to indicate full and markings such as 1/2 can be used to indicate that the liquid is half way between the full and empty tank levels. In this configuration a range of liquid levels will be visible.

This invention may be used to eliminate potential fire and explosions resulting from electronic and electrical devices often used for this purpose. Many other devices require electric current carrying wires to be in or near a fuel tank creating a risk of ignition during accidents. The device may also be used as a substitute to simplify systems that may use more complex level measuring devices. These are the best uses primarily intended by the inventor. The most common configuration is anticipated to be using vertical probes , however horizontal or angled probes will be useful for special applications which could include wing fuel tanks in aircraft.

It is the intent of the inventor that light sensing electronic elements may also be used and thus provide a non mechanical liquid interface. This adaptation will provide the ability to provide electronic signals to control and or indicating devices. Numerous solid state devices are available to provide a light source as well as light detection capability for this type of remote electronic signal application. These devices for providing light include but are not limited to, light admitting diodes, incandescent light bulbs and various laser devices. Likewise several varieties of light detecting elements are available including but limited to solid state infrared and visible light detectors as well as cadmium sulfide cells. Similar light emitting devices can be used to improve the detection of the liquid level when ambient light is not adequate. The light-emitting device can be attached at any position in the optical light path. The light-emitting device can be attached at any position in the optical light path.

1. A liquid level measuring device comprising an optically transparent level probe connected a liquid tank, with a means of attachment for the probe to the tank and for the probe to an optical cable so that when the liquid surface contacts the bottom end of the level probe a visual indication is observable at a remotely located readout connected to the other end of the optical cable to visually indicate liquid level in the tank.

2. The use of a liquid level measuring device comprising an optically transparent level probe connected a liquid tank, with a means of attachment for the probe to the tank and for the probe to an optical cable so that when the liquid surface contacts the bottom end of a the level probe a visual indication is observable at a remotely located readout connected to the other end of the optical cable that will visually indicate liquid level in the tank of an aircraft.

3. The liquid level measuring device of claim 1 wherein the level probe and readout are assemblies configured to display a range of liquid levels.

4. The liquid level measuring device of claim 1 wherein the remotely located readout includes an electronic light sensing element or elements interfacing with electronic control or indicating devices.

5. The liquid level measuring device of claim 2 wherein the remotely located readout includes an electronic light sensing element or elements interfacing with electronic control or indicating devices.

6. The liquid level measuring device of claim 1 including a light-emitting device.

7. The invention of claim 2 including a light-emitting device
